(19) United States
(12) Patent Application Publication
(10) Pub. No.: US 2022/0258361 A1
(43) Pub. Date: Aug. 18, 2022

(54) PACKAGING ROBOT AND METHOD USED TO CARRY OUT A PACKAGING PROCESS

(71) Applicant: Krones Aktiengesellschaft, Neutraubling (DE)

(72) Inventors: Markus PRINZ, Tuntenhausen (DE); Thomas STADLER, Kolbermoor (DE); Simon FELLER, Biberg (DE); Peter DENNEMARCK, Raubling (DE); Christian CANALICCHIO, Bad Endorf (DE); Tobias GUT, Unterhaching (DE)

(21) Appl. No.: 17/672,947

(22) Filed: Feb. 16, 2022

(30) Foreign Application Priority Data
Feb. 17, 2021 (DE) 10 2021 103 751.4

(51) Int. Cl. B25J 15/04; B25J 9/00; B25J 15/02; B25J 9/14; B25J 9/12; B25J 9/16

(52) U.S. Cl. CPC B25J 15/04; B25J 9/0093; B25J 9/1679; B25J 9/14; B25J 9/12; B25J 15/02

(57) ABSTRACT

Disclosed is a packaging robot for articles such as beverage containers or the like. The packaging robot comprises a bridge (3) as well as at least two tool holders (5) arranged at the bridge (3), wherein the at least two tool holders (5) arranged on the bridge (3) are each movable along the bridge (3) and can each accommodate a tool head (7). It is provided that at least one tool holder (5) of the at least two tool holders (5) arranged at the bridge (3) is optionally able to be equipped with a particular tool head (7) adapted to the particular packaging process to be performed. It is also provided that the at least one tool holder (5) of the at least two tool holders (5) can switch into a standby mode while remaining at the bridge (3) if the particular packaging process to be performed by the packaging robot does not require the at least one tool holder (5) to be equipped with a tool head (7).

### CLAIM OF PRIORITY

The present application claims priority to German Application DE 10 2021 103 751.4 filed Feb. 17, 2021, which is incorporated by reference.

### FIELD OF THE INVENTION

The present invention relates to a packaging robot and a method used to perform a packaging process.

### BACKGROUND OF THE INVENTION

A multitude of conceivable stations in the field of beverage technology involve the necessity of discharging beverage containers from a horizontal conveyor and subsequently guiding them on or delivering them to downstream stations. The packaging of beverage containers frequently also requires that outer packagings are taken from a magazine, are expanded, and are deposited onto a horizontal conveyor in order for beverage containers to then be placed into the outer packaging.

In particular in the field of packaging technology, devices are in this context known from the prior art in which the particular beverage containers are received from a horizontal conveyor by a packaging robot and are then placed into packaging units, such as cartons, beverage crates, or the like. Such packaging robots frequently have a multitude of tool heads configured to receive beverage containers or to expand outer packagings and arranged in a position hanging from a bridge.

If beverage containers are intended to be transferred into a particular packaging by the packaging robot, the tool heads are moved along the bridge and, having performed a corresponding movement, they place the beverage containers into a particular outer packaging. Entire facilities for the complete packaging of articles frequently provide a plurality of packaging robots with a particular packaging robot carrying out a particular packaging step.

For example, a first packaging robot can be provided to unfold appropriate cartons and to deposit them on a horizontal conveyor. Another packaging robot can receive beverage containers and can place them into the unfolded cartons deposited on the horizontal conveyor.

A particular tool head of a packaging robot can receive an appropriate number of articles intended to be placed into a particular outer packaging. So if a packaging robot has exactly three tool heads, these can be used to receive articles to be placed into exactly three outer packagings in one step.

If a packaging robot has exactly four tool heads, these can be used to receive articles to be placed into exactly four outer packagings in one step. Such packaging robots that are used for generic facilities operate in a cycled manner, with a particular configuration of a particular packaging robot being adapted to the particular packaging process to be performed.

In the instance of a conversion from an operation with three tool heads to an operation with four tool heads and vice versa, the entire packaging robot or at least a bridge with tool holders for the particular tool heads frequently has to be exchanged for this purpose in current practice. Such a conversion can be necessary in the instance of a packaging format being changed, for example.

The continued operation of the particular packaging robot in the previous configuration would expectably lead to at least a very much reduced throughput. It would be desirable to have appropriate possibilities for the packaging of articles available that offer greater flexibility in such conversions of format.

For this reason, one object of the invention is to be seen in providing a packaging robot and a method to package articles with a high degree of flexibility in terms of format conversion. The packaging robot should moreover have an uncomplicated structure. In addition, the method should be easy to implement.

### SUMMARY OF THE INVENTION

The above objects are fulfilled by a packaging robot and a method having the features in the independent claims. Further advantageous embodiments of the invention are described in the subclaims.

The invention relates to a packaging robot for articles such as beverage containers or the like. The beverage containers packaged by the packaging robot can be beverage bottles and/or beverage cans, for example. In particular, the containers can be PET beverage bottles and/or glass bottles. The packaging intended for the articles or beverage containers can take the form, for example, of a carton or a beverage case or of another type of outer packaging holding together a plurality of articles or a plurality of beverage containers.

The packaging robot comprises a bridge as well as at least two tool holders arranged at the bridge, the tool holders each being movable along the bridge and each being able to accommodate a tool head. The bridge can thus form a linear guide for the at least two tool holders arranged at the bridge. It is in particular possible that the bridge is configured to act as horizontal guide for the at least two tool holders arranged at the bridge.

The packaging robot can furthermore have a control device and/or regulating device making it possible to specify information on the particular packaging process to be performed. In the context of a packaging process to be performed, the control device and/or regulating device can then control at least two tool holders arranged at the bridge in such a manner that the at least two tool holders arranged at the bridge carry out a specified movement relative to each other and are in this context moved along the bridge during a work cycle.

The at least two tool holders arranged at the bridge can thus each be moved horizontally along the bridge within a work cycle, with the at least two tool holders arranged at the bridge in this context first increasing and at a later point in time reducing their relative distance to each other by the at least two tool holders then being moved along the bridge in horizontal direction toward each other.

It is also possible that the packaging robot is designed as a gantry system and that the packaging robot moves the bridge together with the thereat arranged tool heads back and forth along a specified work path within a work cycle.

It is thus possible that:

the packaging robot is designed as a gantry system and that the packaging robot moves the bridge together with the thereat arranged tool heads back and forth along a specified work path within a work cycle in temporal overlap with

at least two tool holders arranged at the bridge being controlled by a control device and/or regulating device in such a manner that these at least two tool holders arranged at the bridge carry out a specified movement relative to each other and are in this context moved along the bridge during the work cycle.

Where required, the packaging robot designed as gantry system can thus move the bridge together with the thereat arranged tool holders alternatingly back and forth along a specified work path. It is thus possible, for example, that the packaging robot moves the bridge together with the at least two tool holders arranged at the bridge back and forth between an infeed supplying articles in the form of beverage containers and a horizontal conveyor configured for the transport of outer packagings.

The at least two tool holders can each be moved along the bridge during such an alternating movement. In this context, it is possible that the packaging robot receives beverage containers from the infeed during such an alternating movement and subsequently places the received beverage containers into outer packagings located on the horizontal conveyor.

One embodiment of the packaging robot can also be configured such that the packaging robot in each instance takes a plurality of outer packagings from a magazine during such an alternating movement, expands the outer packagings, and places them on a horizontal conveyor.

It is provided that the at least one tool holder of the at least two tool holders arranged at the bridge is optionally able to be equipped with a particular tool head adapted to the particular packaging process to be performed. It is furthermore provided that the at least one tool holder of the at least two tool holders is designed such that the at least one tool holder of the at least two tool holders can switch into a standby mode while remaining at the bridge if the particular packaging process to be performed by the packaging robot does not require the at least one tool holder to be equipped with a tool head.

This advantageously makes it possible to use a bridge with a plurality of tool holders for a plurality of different formats. It is conceivable, for example, that the packaging robot comprises exactly four tool holders. Where required, exactly four tool heads can be arranged to the exactly four tool holders in the context of a packaging process to be performed such that a particular tool head can receive a number of articles intended for a particular outer packaging together and can place the appropriate number of the particular received articles into an assigned outer packaging after a movement along the bridge.

If a format change is carried out at a later point in time with exactly three tool heads being required to perform the particular packaging process, the particular tool holder that is no longer needed after the format change can switch into standby mode while continuing to remain at the bridge.

The packaging robot can accordingly perform different packaging processes adapted to particular formats without requiring the bridge with the thereat arranged tool holders to be exchanged. The tool holder that is not required for the particular packaging process can switch into a standby mode or on-call mode, from which the at least one tool holder can be reactivated anytime and without preparations or longer waiting times when the packaging process is changed again if the particular packaging process to be performed by the packaging robot provides a packaging step via a tool head to be arranged to the at least one tool holder.

It is possible that a particular tool head requires a hydraulic, pneumatic, and/or electric power supply in order to perform the particular packaging process. The hydraulic, pneumatic, and/or electric power supply can be providable by the at least two tool holders arranged at the bridge for a particular tool head arranged to a particular tool holder.

It is possible that the at least one tool holder is configured to cut off an hydraulic, pneumatic, and/or electric power supply for a tool head when in standby mode or to block a hydraulic, pneumatic, and/or electric power supply for a tool head when in standby mode.

A particular tool head can comprise a plurality of suction elements and/or gripping elements by which the articles or beverage containers can be received. The suction elements and/or gripping elements can be formed by so-called packing bells, for example. It is thus possible that the plurality of suction elements and/or gripping elements are each configured to receive a particular beverage container in a pneumatic manner.

Such a tool head can furthermore have centering elements to guide the particular beverage containers under contact while the beverage containers are being placed into a particular outer packaging. In one embodiment, the packaging robot can therefore be configured to receive articles and to place received articles into a particular outer packaging. In such embodiments, it has also proved successful for the packaging robot to be designed as a gantry system.

Alternatively, it is however also conceivable that the packaging robot is a multi-axis robot or another type of handling device.

It is also possible for a particular tool head to comprise at least one working tool used to receive and expand an outer packaging that is provided for articles or beverage containers to be placed thereinto. In one embodiment, the packaging robot can therefore be configured to handle outer packagings provided for articles or beverage containers to be placed thereinto.

In such embodiments, it has also proved successful for the packaging robot to be designed as a gantry system. Alternatively, it is however also conceivable that the packaging robot is a multi-axis robot or another type of handling device.

If the particular at least one tool holder has switched into or is in standby mode, it is possible that a tool head continues to be arranged to the at least one tool holder, with the tool head that is not required for the particular packaging process nevertheless continuing to remain in the tool holder that is in standby mode while the particular packaging process is being performed.

It is also possible that the particular at least one tool holder switches into standby mode and that the tool head arranged until then in the at least one tool holder is removed from the at least one tool holder before the packaging robot performs the particular packaging process.

It is possible, for example, that the at least one tool holder of the at least two tool holders arranged at the bridge is arranged to be immovable in a waiting position at the bridge when in standby mode. The waiting position can be configured such that none of the remaining tool holders collides with the at least one tool holder arranged in the waiting position while the packaging robot is performing its particular packaging process.

The waiting position can be situated in an edge area of the bridge such that a tool head can be arranged to the at least one tool holder in waiting position if this is required for a packaging process to be performed by a packaging robot at a later point in time. The tool holder arranged in the waiting position until then can thereafter switch from the standby mode into an active state and leave the waiting position.

The waiting position can, in particular, be configured such that a user can remove a tool head arranged to the at least one tool holder in the waiting position from the at least one tool holder in the waiting position.

The packaging robot can also comprise at least one pneumatic cylinder and/or at least one servo drive which can transfer the at least one tool holder into the waiting position where the at least one tool holder is arranged to be immovable at the bridge. Where required, the at least one pneumatic cylinder and/or the at least one servo drive can transfer the at least one tool holder into the waiting position by sliding the at least one tool holder along the bridge into the waiting position.

Alternatively or additionally, it can be provided that the packaging robot comprises at least one linear motor, which can transfer the at least one tool holder into the waiting position where the at least one tool holder is arranged to be immovable at the bridge.

It is furthermore possible that the at least one tool holder of the at least two tool holders is designed to be movable along the bridge when in standby mode. It is thus possible for the at least one tool holder to continue to be moved along with the remaining tool holders during the particular packaging process to be performed by the packaging robot even if the particular packaging process to be performed by the packaging robot does not require the at least one tool holder to be equipped with a tool head.

Embodiments have proved successful in which the at least one tool holder comprises a quick-change mechanism via which a tool head can be arranged preferably without tools to the at least one tool holder and/or via which a tool head can be removed preferably without tools from the at least one tool holder.

It has proved successful, for example, for the quick-change mechanism to be configured such that the tool head can be hinged preferably without tools into the at least one tool holder and/or such that the tool head can be detached preferably without tools from the at least one tool holder. It is possible for the quick-change mechanism to comprise a latch connection, snap connection, and/or clamp connection to detachably secure a particular tool head to the at least one tool holder.

It is furthermore possible that the at least two tool holders arranged at the bridge can each provide a preferably electric and/or pneumatic power supply for a tool head, with the at least one tool holder being designed such that the preferably pneumatic and/or electric power supply providable for the particular tool head is shut off or deactivated when in standby mode.

The packaging robot can comprise a control device and/or regulating device in contact with the at least one tool holder in such a manner that the control device and/or regulating device independently shuts off the preferably pneumatic and/or electric power supply providable for the particular tool head when in standby mode.

The invention moreover relates to a method used to perform a packaging process for articles such as beverage containers or the like. Features that have already been described above regarding various embodiments of the packaging robot can likewise be provided for the embodiments of the method according to the invention described below, and they are therefore not repeatedly mentioned. Features that are described below regarding various embodiments of the method can likewise be provided for various embodiments of the packaging robot already described above. The previously described packaging robot can be configured in various embodiments to perform the embodiments of the method described as follows.

In the method, a packaging robot with a bridge as well as with at least two tool holders arranged at the bridge is provided, with the at least two tool holders arranged at the bridge each being movable along the bridge and each being able to accommodate a tool head.

One step of the method provides a selection of a specific packaging process out of a plurality of different packaging processes, which plurality of different packaging processes selectively equip a particular tool head to the at least two tool holders arranged at the bridge. The selection of the specific packaging process can be carried out via a control device and/or regulating device, which provides a control panel for the selection of the specific packaging process.

Another step provides a performing of the selected packaging process by the packaging robot, with the packaging robot performing the selected packaging process by the tool holders equipped with tool heads corresponding to the selected packaging process, and for this purpose moving the equipped tool holders together with the tool heads or together with the thereto arranged tool heads along the bridge.

It is provided that at least one tool holder of the at least two tool holders switches into a standby mode or on-call mode as needed while remaining at the bridge, in which standby mode or on-call mode the at least one tool holder remains while the selected packaging process is being performed if the particular selected packaging process does not require the at least one tool holder to be equipped with a tool head.

It is furthermore possible that the at least one tool holder remains immovable in a waiting position at the bridge when in standby mode while the selected packaging process is being performed.

It is also conceivable that the at least one tool holder is transferred into the waiting position by a pneumatic cylinder and/or by a servo drive. Embodiments have alternatively proved successful in which the at least one tool holder is transferred into the waiting position by a linear motor.

It is conceivable that the at least one tool holder in standby mode of the at least two tool holders is moved along together with the remaining tool holders while the selected packaging process is being performed.

It is also possible that the tool holders equipped with tool heads via the selected packaging process preferably each supply their particular tool head with pneumatic and/or electric power while the selected packaging process is being performed. In this context, it is possible that an electric and/or pneumatic power supply of the at least one tool holder provided for a tool head is switched off or deactivated during the standby mode.

### BRIEF DESCRIPTION OF THE FIGURES

In the following passages, the attached figures further illustrate typical embodiments of the invention and their advantages. The size ratios of the individual elements in the figures do not necessarily reflect the real size ratios. It is to be understood that in some instances various aspects of the invention may be shown exaggerated or enlarged in relation to other elements in order to facilitate an understanding of the invention.

FIGS. 1 and 2 show an embodiment of a bridge such as can be provided in various embodiments of a packaging robot according to the invention.

FIGS. 3 and 4 each show schematic views of an article packaging facility in which embodiments of a packaging robot according to the invention are used.

FIGS. 5 and 6 each show schematic views of another article packaging facility in which embodiments of a packaging robot according to the invention are used.

FIG. 7 shows a flowchart of individual steps such as can be provided in an embodiment of a method according to the invention.

### DETAILED DESCRIPTION OF THE INVENTION

The same or equivalent elements of the invention are designated using identical reference characters. Furthermore and for the sake of clarity, only the reference characters relevant for describing the individual figures are provided. It should be understood that the detailed description and specific examples, while indicating preferred embodiments, are intended for purposes of illustration only and are not intended to limit the scope of the invention.

The embodiments, examples and alternatives of the preceding paragraphs, the claims, or the following figures and description, including any of their various aspects or respective individual features, may be taken independently or in any combination. Features described in connection with one embodiment are applicable to all embodiments, unless such features are incompatible.

If illustrations and aspects are generally referred to as being “schematic” in the context of the figures, this is by no means intended to imply that the illustrations of the figures and their description are of inferior significance with regard to the disclosure of the invention. The person skilled in the art is fully capable of gathering sufficient information from the schematically and abstractly drawn illustrations for facilitating the understanding of the invention without the understanding being in any way impaired by, for example, the size ratios being drawn and being potentially not precisely true to scale. On the basis of the more concretely explained realizations of the method according to the invention and on the basis of the more concretely explained functionality of the packaging robot according to the invention in the figures, the person skilled in the art as a reader is thus enabled to derive a better understanding of the inventive idea, which is formulated in a more general and/or more abstract manner in the claims and in the general part of the description.

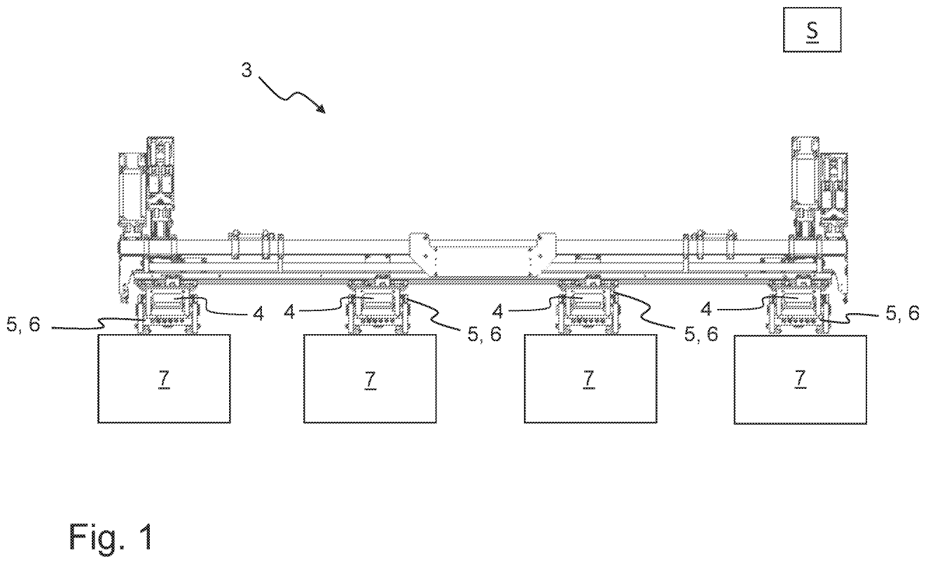

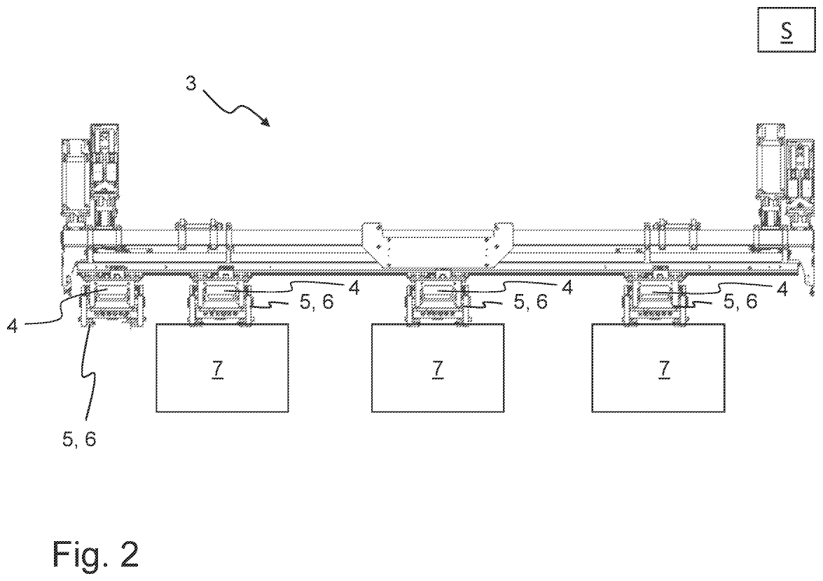

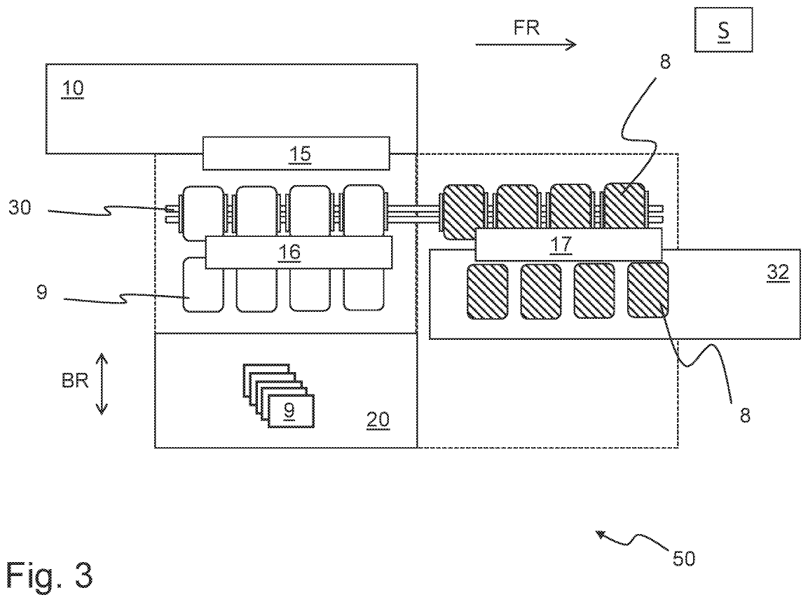

FIGS. 1 and 2 show an embodiment of a bridge 3 such as can be provided in various embodiments of a packaging robot 15, 16, 17 (cf. FIGS. 3 to 6) according to the invention. In the present instance, four tool holders 5 are arranged at the bridge 3, each of the tool holders being configured as quick-change mechanism and each carrying a tool head 7.

The tool heads 7 are merely schematically indicated, and they can each have a plurality of suction instruments that are controllable via negative pressure and that receive beverage containers to be transferred into a particular outer packaging. The tool heads 7 can also each comprise a working tool that can seize and expand a particular folded outer packaging 9 (cf. FIGS. 3 to 6).

The configuration illustrated in FIG. 1 of the bridge 3 with four tool holders 5 and four thereto arranged tool heads 7 is provided to perform a packaging process as is shown in the schematic view according to FIG. 3.

FIG. 3 shows a layout of a facility 50, which can package articles in the form of beverage containers. For this purpose, the article packaging facility 50 comprises three packaging robots illustrated with the reference numbers 15, 16, and 17. Each of these packaging robots 15, 16, and 17 comprises a bridge 3 with exactly four tool holders 5 arranged thereto, the tool holders 5 each carrying a tool head 7 according to FIG. 1.

The packaging robots 15, 16, and 17 are moreover each designed as a gantry system and can thus move the bridge 3 together with the tool holders 5 and the tool heads 7 arranged to the tool holders 5 as a gantry system.

The bridge 3 is thus guided as a component of a gantry system, and for packaging articles, it can be moved together with the tool holders 5 arranged at the bridge 3 and the tool heads 7 arranged to the tool holders 5.

With regard to the schematic view according to FIG. 1, the tool holders 5 can be moved, together with the tool heads 7, back and forth, perpendicular to the image plane by the packaging robot 15, 16, and 17 designed as a gantry system accordingly moving the bridge 3. This direction along which the gantry system moves the bridge 3 back and forth is indicated in FIG. 3 by an arrow-based illustration in movement direction BR.

In the article packaging facility 50 as illustrated in FIG. 3, the packaging robot 15 comprises four tool heads 7, which are each arranged to a tool holder 5 and which are being carried by a bridge 3 according to FIG. 1. The tool heads 7 of the packaging robot 15 each comprise a plurality of pneumatic, controllable suction instruments, which can each temporarily receive beverage containers via negative pressure in order for the beverage containers to be placed into the outer packagings illustrated with the reference number 9.

In this context, each of the four tool heads 7 can receive a number of beverage containers corresponding exactly to a number of beverage containers to be placed into an assigned outer packaging 9. The packaging robot 15 thus operates in a cycled manner and in each cycle receives a number of beverage containers intended to be placed into four assigned outer packagings 9, transports these beverage containers toward the four outer packagings 9, and then places these beverage containers in a direction coming from above into the four outer packagings 9.

If the article packaging facility 50 is used, for example, to produce packs 8 comprising exactly six beverage containers, the tool heads 7 of the packaging robot 15 each receive exactly six beverage containers. These beverage containers are supplied via an infeed 10 guiding the beverage containers in a plurality of parallel rows along the conveying direction FR, which infeed 10 can comprise a plurality of lane guides to form the plurality of parallel rows.

Like the packaging robot 15, the packaging robot 16 also comprises a bridge 3 with exactly four tool holders 5 arranged thereat, the tool holders 5 each being configured as a quick-change mechanism 6. According to the illustration of FIG. 1, exactly four tool heads 7 are arranged likewise to the tool holders 5 of the packaging robot 16.

The tool holders 5 of the packaging robot 16 can also be moved, together with the thereto arranged tool heads 7, back and forth in the direction BR indicated with arrow-based illustration in FIG. 3 by the bridge 3 being accordingly moved via the gantry system. In contrast to the packaging robot illustrated in FIG. 3 with reference number 15, the tool heads 7 in the packaging robot 16 are equipped with work tools via which the tool heads 7 of the packaging robot 16 can take folded outer packagings 9 from the magazine 20, can expand the folded outer packagings 9, and can then deposit the outer packagings 9 on the horizontal conveyor 30.

For this purpose, the packaging robot 16 moves its bridge 3 back and forth between the magazine 20 and the horizontal conveyor 30. The packaging robot 16 also operates in a cycled manner and can take exactly four outer packagings 9 from the magazine 20 in one step, can then expand these four outer packagings 9 taken from the magazine 20, can move four outer packagings 9 toward the horizontal conveyor 30, and can deposit four outer packagings 9 at least approximately simultaneously on the horizontal conveyor 30.

In this context, the configuration of the packaging robot 15 is adapted to the configuration of the packaging robot 16. As already mentioned, the packaging robot 16 can take exactly four outer packagings 9 simultaneously from the magazine 20, can expand them, and can then deposit the four outer packagings 9 on the horizontal conveyor 30. The packaging robot 15 can receive exactly four article assemblies simultaneously from the infeed 10, which article assemblies are to be placed into these four outer packagings 9, can move the four article assemblies to the horizontal conveyor 30, and can then place the four article assemblies into the exactly four outer packagings already having been deposited by the packaging robot 16 on the horizontal conveyor 30 for this purpose.

The outer packagings 9 are moved together with the articles placed therein into the working range of the packaging robot 17 by the horizontal conveyor 30. The packaging robot 17 is also designed as a gantry system and has a bridge 3, which the packaging robot 17 designed as gantry system can move back and forth in the movement direction BR between the horizontal conveyor 30 and the further horizontal conveyor 32.

Again, exactly four tool holders 5 with exactly four tool heads 7 located thereto are arranged at the bridge 3 of the packaging robot 17 designed as a gantry system. Again, the packaging robot 17 can thus receive four outer packagings 9 with articles placed therein or four packs 8 simultaneously from the horizontal conveyor 30, move them toward the further horizontal conveyor 32, and deposit them on the further horizontal conveyor 32 by using a cycle.

After having deposited these four outer packagings 9 with the articles or beverage containers placed therein on the further horizontal conveyor 32, the packaging robot 17 can move the bridge 3 back toward the horizontal conveyor 30 and can again receive four further outer packagings 9 with articles placed therein within a further cycle. The configuration of the packaging robot 17 is thus also in each instance adapted to the configuration of the packaging robot 15 and to the configuration of the packaging robot 16.

It is thus discernible from the described operating mode of the article packaging facility 50 as designed in FIG. 3 that the packaging robots 15, 16, and 17 each have to be configured such that a specified packaging process corresponding to a specific format can be performed together by the packaging robots 15, 16, and 17. If the packaging process or the format is changed, it may be possible that the article packaging facility 50 according to a configuration of FIG. 3 is not able to perform this packaging process or yields a reduced throughput.

In practice, a change of the packaging process therefore frequently makes it necessary that each of the bridges 3 of the packaging robots 15, 16, and 17 is exchanged, which requires inconvenient conversions and leads to a disruption of a packaging process to be performed via an article packaging facility 50 until the conversion has been completed.

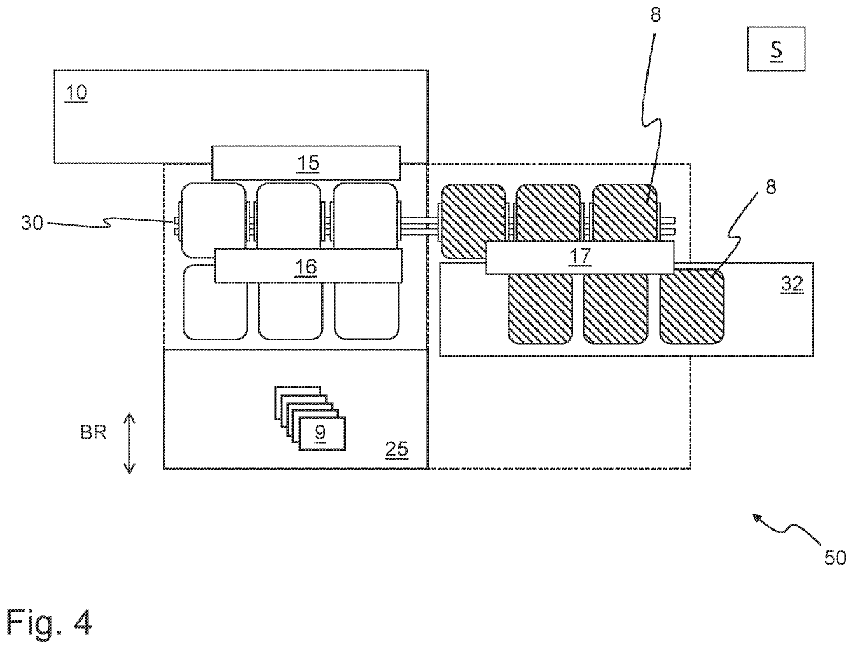

It is discernible from FIG. 4 that the article packaging facility 50 of FIG. 3 has undergone a change of configuration or a format change. Articles or beverage containers continue to be supplied via the infeed 10 in a plurality of parallel rows and to be transported into a working range of the packaging robot 15. The packaging robot 15 in the configuration of an article packaging facility 50 according to FIG. 4 continues to receive beverage containers from the infeed 10, to transport these beverage containers toward the horizontal conveyor 30, and to then place the beverage containers into assigned outer packagings 9.

As already explained above with regard to the article packaging facility 50 according to FIG. 3, a plurality of beverage containers are received from the infeed 10 simultaneously in the appropriate number of beverage containers to be placed into exactly four outer packagings 9 within a work cycle. In the configuration of an article packaging facility 50 according to FIG. 4 it is by contrast provided that the packaging robot 15 receives beverage containers from the infeed 10 in the appropriate number of beverage containers that are placed into exactly three assigned outer packagings 9 within a work cycle.

For this purpose, the packaging robot 15 in the configuration of an article packaging facility 50 according to FIG. 4 comprises a bridge 3 as is illustrated in FIG. 2. FIG. 2 shows that a tool head 7 is arranged to each of the three tool holders 5, which are each configured as a quick-change mechanism 6. Via each of these tool heads 7 it is possible to receive in each instance a number of articles or beverage containers to be placed into a particularly assigned outer packaging 9 within a work cycle.

A fourth tool head, as is required for each of the packaging robots 15, 16, and 17 in the configuration of an article packaging facility 50 according to FIG. 3, can be omitted in the configuration of an article packaging facility 50 according to FIG. 4.

The configuration of an article packaging facility 50 according to FIG. 4 does not require a fourth tool head 7 in order to receive articles or beverage containers from the infeed 10 and to place them in a corresponding outer packaging 9, so the tool holder 5 without a tool head 7 that is illustrated on the left side in FIG. 2 is in standby mode, in which this tool holder 5 remains at the bridge 3. An active mode of the tool holder 5, in which the tool holder 5 receives articles via a tool head 7 and places them into an outer packaging 9 during a packaging process, can be switched into a standby mode of the tool holder 5, as is illustrated in FIG. 2.

The standby mode in the exemplary embodiment of a bridge 3 according to FIGS. 1 and 2 is sometimes characterized in that the tool holder 5 illustrated on the left side moves into the waiting position shown in FIG. 2 and remains in this waiting position while the packaging robot 15 receives beverage containers from the infeed 10, moves the beverage containers toward the horizontal conveyor 30, and then places them into an assigned outer packaging 9.

All tool holders 5 arranged at the bridge 3 according to FIGS. 1 and 2 have own drives 4, which can be designed as linear motors, servomotors, or as pneumatic cylinders, for example. The tool holder 5 not required for the particular packaging process to be performed can move into the waiting position according to FIG. 2 via its own drive 4, and it can remain in the particular waiting position while the particular packaging process is being performed.

It has proved successful, for example, that the packaging process to be performed by the packaging robots 15, 16, and 17 or by the article packaging facility 50 is specified to the control device and/or regulating device S by a user. The control device and/or regulating device S can then control the particular own drive 4 of a particular tool holder 5 as required such that the particular tool holder 5 moves independently into a waiting position if the particular tool holder 5 or a tool head 7 to be arranged thereto is not required in order to perform the particular packaging process.

During an operation of the particular packaging robot 15, 16, and 17, the particular tool heads 7 arranged to a particular tool holder 5 are supplied with power or with electric or pneumatic power via the particular tool holder 5. Such a supply with electric or pneumatic power for a tool head 7 can be cut off for a tool holder 5 by the control device and/or regulating device S when the particular tool holder 5 is in standby mode. This can prevent a tool head 7 from carrying out operations when the tool head 7 is not required for the particular packaging process or when it is arranged to a tool holder 5 in standby mode.

In practice, however, it is advantageous for the particular tool head 7 to be removed from the particular tool holder 5 when it is not required for the particular packaging process. FIG. 2 also shows that the tool holder 5 in standby mode is situated in an edge area of the bridge 3 such that a tool head 7 possibly still arranged to the tool holder 5 can be easily removed from the tool holder 5.

With the tool holders 5 each being configured as quick-change mechanism 6, a removal of a particular tool head 7 from a particular tool holder 5 can moreover be carried out in a time-optimized manner.

It is moreover discernible from FIG. 4 that the packaging robot 16 takes three outer packagings 9 from the magazine 25 and deposits them on the horizontal conveyor 30 in each cycle. Furthermore, it is discernible from FIG. 4 that the packaging robot 17 in each instance receives three packs 8 from the horizontal conveyor 30 and transfers them to the horizontal conveyor 32 or deposits the three packs 8 on the horizontal conveyor 32 within a particular cycle.

The packaging robots 16 and 17 also require exactly three tool heads 7 in order to perform their particular work cycle, with a fourth tool head 7 as illustrated in FIG. 1 not being required for the configuration of an article packaging facility 50 according to FIG. 4. Exactly one tool holder 5 in each of the packaging robots 16 and 17 is therefore also in standby mode and in this context arranged to be immovable in a waiting position as shown in FIG. 2. The particular tool holder 5 is brought into the particular waiting position via an own drive 4, which can be designed as linear motor, servomotor, or as pneumatic cylinder, for example. The configurations of the packaging robots 15, 16, and 17 are thus also adapted to each other in the article packaging facility 50 according to FIG. 4.

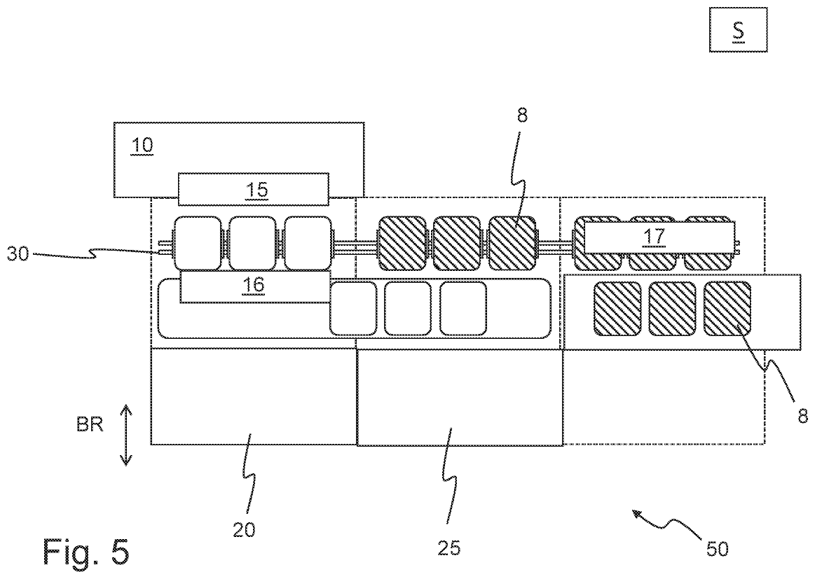

FIG. 5 shows a schematic view of another embodiment of an article packaging facility 50. The configuration of the article packaging facility 50 according to FIG. 5 corresponds to the configuration of the article packaging facility 50 according to FIG. 4. For each of the bridges 3 of the packaging robots 15, 16, and 17, a particular tool holder 5 is therefore in standby mode and arranged in a particular waiting position. An electric or hydraulic power supply for a tool head 7 is in each instance deactivated for the particular tool holder in standby mode.

It is discernible from FIGS. 4 and 5 seen in conjunction that the embodiment of the article packaging facility 50 according to FIG. 5 has a first magazine 20 and a second magazine 25. The first magazine 20 accommodates folded outer packagings 9 prepared for a packaging process in which the packaging robot 16 takes four outer packagings 9 simultaneously from the magazine 20, expands the outer packagings 9, and deposits them on the horizontal conveyor 30. The second magazine 25 accommodates folded outer packagings 9 prepared for a packaging process in which the packaging robot 16 takes exactly three outer packagings 9 simultaneously from the magazine 25, expands the outer packagings 9, and deposits them on the horizontal conveyor 30.

Depending on the particular packaging process to be performed, the packaging robot 16 can optionally take folded outer packagings 9 from the first magazine 20 or from the second magazine 25. Both the first magazine 20 and the second magazine 25 are situated within a working range of the packaging robot 16 such that their position does not need to be changed if the particular packaging processes are changed. A change between different packaging processes can be carried out in a fast and uncomplicated manner in such embodiments.

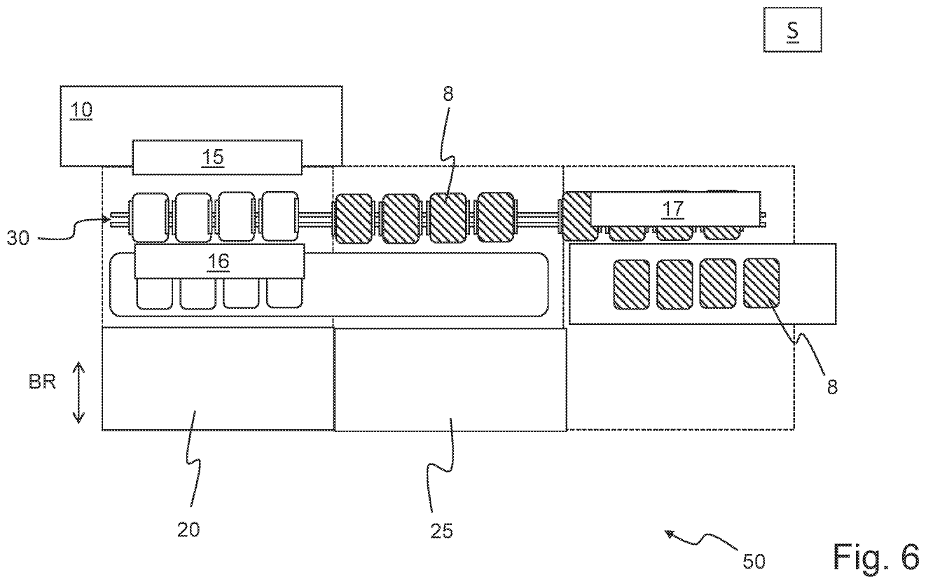

FIGS. 5 and 6 seen in conjunction illustrate such a change. The packaging robot 16 in FIG. 5 still takes exactly three outer packagings 9 from the second magazine 25, expands the outer packagings 9, and deposits them on the horizontal conveyor 30 within a particular work cycle, whereas in the configuration of the article packaging facility 50 according to FIG. 6, exactly four outer packagings 9 are taken from the first magazine 20, are expanded, and are then deposited on the horizontal conveyor 30 by the packaging robot 16 within a particular cycle.

Both in the configuration of the article packaging facility 50 according to FIG. 5 and in the configuration of the article packaging facility 50 according to FIG. 6, the first magazine 20 and the second magazine 25 are each designed as components of the article packaging facility 50, and they remain installed as fixed components of the article packaging facility 50 without being removed from the article packaging facility 50 in the instance of a packaging process being changed.

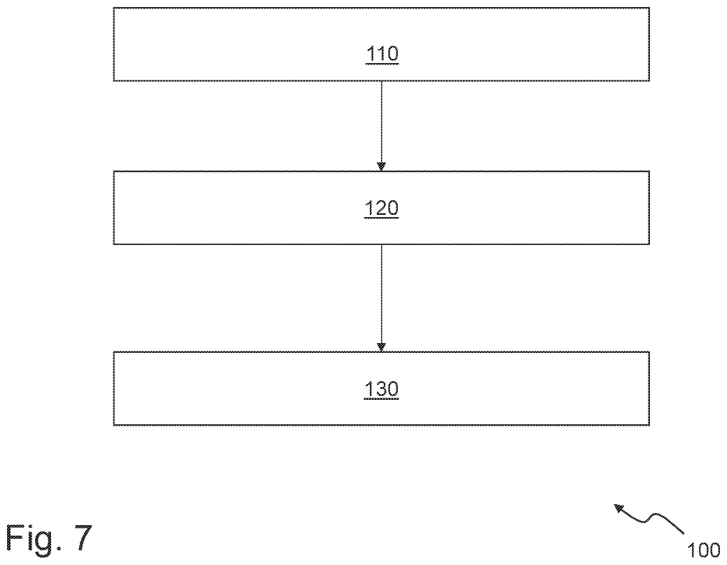

FIG. 7 shows a flowchart of individual steps such as can be provided in an embodiment of a method 100 according to the invention. To perform the method as illustrated in the individual steps of FIG. 7, a packaging robot 15, 16, or 17 is provided with a bridge 3 and with a plurality of tool holders 5 arranged at the bridge 3, with the plurality of tool holders 5 arranged at the bridge 3 each being movable along the bridge 3 and each being able to accommodate a tool head 7.

In the context of a first step indicated with reference number 110, a specific packaging process is selected from a plurality of different packaging processes, which selectively equip a particular tool head 7 to the at least two tool holders 5 arranged at the bridge 3. The selection of the specific packaging process is carried out via a control device and/or regulating device S, for which a user specifies information on the particular packaging process to be performed.

In the context of a further step 120, the control device and/or regulating device S checks which of the tool holders 5 require to be equipped with a particular tool head 7 in order for the particular selected packaging process to be performed. If the control device and/or regulating device S determines that the performing of the selected packaging process requires no equipping of one or more of the tool holders 5 with a tool head 7, the control device and/or regulating device S causes the one or more tool holders 5 to switch into standby mode in step 120. For this purpose, these tool holders 5 or this one tool holder 5 are/is moved into a particular waiting position and in this context continue/continues to be arranged at the bridge 3.

Step 120 is followed by method step 130. In step 130, the packaging process is performed by the packaging robot 15, 16, or 17. In this context, the packaging robot 15, 16, or 17 moves the tool holders 5 equipped with tool heads 7 along the bridge 3 and hereby performs a packaging step necessary to produce an article pack 8. It is possible in this context that the packaging robot 15, 16, or 17 moves articles toward an outer packaging 9 and places the articles into the particular outer packaging 9.

It is also possible that the packaging robot 15, 16, or 17 in this context takes outer packagings 9 from a magazine 20 or 25 expands the outer packagings 9, and then deposits them on a horizontal conveyor 30. While the packaging process is being performed, the tool holders 5 that do not require to be equipped with a tool head 7 for the performing of the selected packaging process continue in the standby mode, which the tool heads 7 have already switched to prior to the start of the packaging process.

The invention has been described with reference to a preferred embodiment. Those skilled in the art will appreciate that numerous changes and modifications can be made to the preferred embodiments of the invention and that such changes and modifications can be made without departing from the spirit of the invention. It is therefore intended that the appended claims cover all such equivalent variations as fall within the true spirit and scope of the invention.

### LIST OF REFERENCE NUMBERS

3 Bridge

4 Own drive

5 Tool holder

6 Quick-change mechanism

7 Tool head

8 Pack

9 Outer packaging

10 Infeed

15 Packaging robot

16 Packaging robot

17 Packaging robot

20 Magazine, first magazine

25 Magazine, second magazine

30 Horizontal conveyor

32 Further horizontal conveyor

50 Article packaging facility

100 Method

110 First method step

120 Second method step

130 Third method step

BR Movement direction

FR Conveying direction

S Control device and/or regulating device

1. A packaging robot (15, 16, 17) for articles, comprising:
a bridge (3) and at least two tool holders (5) arranged at the bridge (3), wherein the at least two tool holders (5) are each movable along the bridge (3) and can each accommodate a tool head (7), wherein:
at least one tool holder (5) of the at least two tool holders (5) is optionally able to be equipped with a particular tool head (7) adapted to the particular packaging process to be performed, and wherein the at least one tool holder (5) of the at least two tool holders (5) is designed such that it can switch into a standby mode while remaining at the bridge (3) if the particular packaging process to be performed by the packaging robot (15, 16, 17) does not require the at least one tool holder (5) to be equipped with a tool head (7).

2. The packaging robot of claim 1, wherein the at least one tool holder (5) is arranged in a waiting position at the bridge (3) when in standby mode.

3. The packaging robot of claim 2, further comprising at least one pneumatic cylinder, wherein the at least one pneumatic cylinder can transfer the at least one tool holder (5) into the waiting position.

4. The packaging robot of claim 2, further comprising at least one servo drive, wherein the at least one servo drive can transfer the at least one tool holder (5) into the waiting position.

5. The packaging robot of claim 2, wherein each of the at least two tool holders (5) is associated with an own drive (4), such that the own drive (4) can bring each of the at least two tool holders into a waiting position.

6. The packaging robot of claim 5, wherein each own drive (4) comprises a pneumatic cylinder or a servo drive.

7. The packaging robot of claim 2, wherein the at least one tool holder (5) is movable along the bridge (3) when in standby mode.

8. The packaging robot of claim 2, wherein each of the at least two tool holders (5) each has an electric or pneumatic power supply to a tool head (7), wherein the power supply is shut off or deactivated when in standby mode.

9. The packaging robot of claim 2, wherein each of the at least two tool holders (5) comprises a quick-change mechanism (6), via which quick-change mechanism (6), a tool head (7) can be arranged without tools to the at least one tool holder (5), or via which quick-change mechanism (6), a tool head (7) can be removed without tools.

10. The packaging robot of claim 2, wherein the bridge (3) is part of a gantry system, and which gantry system can move the bridge (3) together with the tool heads (7) back and forth along a specified work path within a work cycle.

11. A method (100) used to perform a packaging process for articles comprising:
providing a packaging robot (15, 16, 17) with a bridge (3) and at least two tool holders (5) arranged at the bridge (3), wherein the at least two tool holders (5) are each movable along the bridge (3) and can each accommodate a tool head (7);
selecting a specific packaging process out of a plurality of different packaging processes, and equipping the at least two tool holders (5) with a particular tool head (7),
performing of the selected packaging process by the packaging robot (15, 16, 17) by at least moving the equipped tool holders (5) together with the tool heads (7) along the bridge (3),
wherein at least one tool holder (5) of the at least two tool holders (5) switches into a standby mode wherein the at least one tool holder (5) remains while the selected packaging process is being performed if the selected packaging process does not require the at least one tool holder (5) to be equipped with a tool head (7).

12. The method of claim 11, wherein the at least one tool holder (5) of the at least two tool holders (5) is in a waiting position when in standby mode while the selected packaging process is being performed.

13. The method of claim 12, wherein the at least one tool holder (5) is transferred into the waiting position by a pneumatic cylinder.

14. The method of claim 12, wherein the at least one tool holder (5) is transferred into the waiting position by a servo drive.

15. The method of claim 11, wherein the at least one tool holder (5) of the at least two tool holders (5), when in standby mode, is moved with the remaining tool holders (5) while the selected packaging process is being performed.

16. The method of claim 11, wherein the tool holders (5) each supply their particular tool head (7) with electric or pneumatic power while the selected packaging process is being performed, and wherein the electric or pneumatic power is switched off during the standby mode.

17. The packaging robot of claim 2, wherein the at least one tool holder (5) is immovable when in standby mode.

18. The packaging robot of claim 12, wherein the at least one tool holder (5) is immovable when in standby mode.
